(19) United States
(12) Patent Application Publication
(10) Pub. No.: US 2015/0240087 A1
(43) Pub. Date: Aug. 27, 2015

(54) CELLULOSE FIBER THERMAL BARRIER AND METHODS FOR ITS APPLICATION

(71) Applicant: Jeffrey J. Van Moorsel, Camlachie (CA)

(72) Inventor: Jeffrey J. Van Moorsel, Camlachie (CA)

(21) Appl. No.: 14/603,145

(22) Filed: Jan. 22, 2015

Related U.S. Application Data
(60) Provisional application No. 61/930,354, filed on Jan. 22, 2014.

(51) Int. Cl. C09D 5/18; B05D 1/02

(52) U.S. Cl. CPC C09D 5/18; B05D 1/02

(57) ABSTRACT

There is disclosed a cellulose fiber thermal barrier and a method for its application. In an embodiment, the method comprises preparing a cellulose fiber thermal barrier material including joint compound, dry powder glue and dry fire retardant; mixing the cellulose fiber cellulose fiber thermal barrier material with a liquid binder mix and water; and spraying the mixture under pressure onto a surface. This cellulose fiber thermal barrier applied to a thickness of about 1¼ to 1½ inches may provide a class B, 10-minute thermal barrier in accordance with the CAN4-2124-M standard of the National Building Code.

### FIELD OF THE INVENTION

The present invention relates generally to the field of thermal barriers, and more particularly to a cellulose fiber thermal barrier and methods for its application.

### BACKGROUND

Cellulose fiber materials, including plant fiber or wood fiber materials such as recycled newspaper, can provide an economical way to insulate a building, such as a residential home, with thermal resistance R-values of up to 3.8 per inch.

While cellulose fiber insulation material can be easily blown on top of horizontal surfaces, such as when applied as attic insulation, application of the cellulose fiber insulation material onto vertical surfaces, such as wood stud walls of residential homes, or even over head ceiling applications can be significantly more challenging due to sensitivity of cellulose fiber insulation material to moisture content, both contained within the cellulose fiber insulation material and in the ambient air.

Furthermore, untreated cellulose fiber material is flammable, and therefore cellulose fiber insulation material must be suitably treated to make the insulation material suitable for use as building insulation. However, existing treatment options provide minimal levels of thermal protection.

What is needed are further improvements in thermal barriers to decrease material and application costs, and enhance safety and performance.

### SUMMARY

The present invention relates to a cellulose fiber thermal barrier and a method for its application.

In an embodiment, the method comprises spraying a poly-urethane foam insulation material onto a surface; then spraying a cellulose fiber adhesive mixture over the poly-urethane foam insulation material as thermal barrier. This cellulose fiber adhesive mixture applied directly over the poly-urethane foam insulation material results in a class B, 10-minute thermal barrier in accordance with the CAN4-2124-M standard of the National Building Code. Further more, this applied thermal barrier conforms with CAN/ULC S1010-M such that the material will not exceed an average temperature rise of 140° C. on its unexposed face after a period of 10 minutes when exposed to a temperature of 704° C. Advantageously, the resulting thermal barrier formed by the cellulose fiber adhesive mixture provides significantly longer protection against heat than prior art cellulose fiber insulation materials, and also provides further insulation R-value in addition to the thermal barrier protected poly-urethane foam insulation.

In an aspect, there is provided a cellulose fiber thermal barrier material, comprising: cellulose fiber; joint compound; dry powder glue; and dry fire retardant power; whereby, when the cellulose fiber thermal barrier material is mixed with a liquid binder mix and water, the resulting mixture is suitable for spraying onto a vertical surface.

In another aspect, there is provided a method of applying a cellulose fiber thermal barrier material; comprising: preparing a cellulose fiber thermal barrier material including joint compound, dry powder glue and dry fire retardant powder; mixing the cellulose fiber cellulose fiber thermal barrier material with a liquid binder mix and water; and spraying the mixture under pressure.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present invention will be better understood and objects of the invention will become apparent when consideration is given to the following detailed description thereof. Such description makes reference to the annexed drawings wherein:

FIG. 1 shows an illustration of a poly-urethane foam insulation material covered by a cellulose fiber thermal barrier on a vertical surface in accordance with an embodiment.

FIG. 2 shows an illustrative process for applying a poly-urethane insulation material followed by a cellulose fiber thermal barrier to a vertical surface in accordance with an embodiment.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

As noted above, the present invention relates to a cellulose fiber thermal barrier and method for its application to a surface.

A thermal barrier can be described as a material which limits the speed by which heats transfers through a material. The CAN4-S124-M standard defines the test for conformity, and requires that a thermal barrier will not exceed an average temperature rise of 140° C. on its unexposed face after a period of 10 minutes when exposed to a temperature of 704° C.

When poly-urethane foam insulation is applied, the foam insulation must be protected by a thermal barrier which protects the foam insulation from heat. Conventionally, this thermal barrier is a non-flammable sheet material, such as gypsum board, or a material by hand, such as lath and plaster, masonry, or concrete. While these materials are effective thermal barriers, their application can be laborious and time-consuming, and can only be done where wood or steel studs are available to fasten these thermal barriers.

Advantageously, the present method for installing a cellulose fiber thermal barrier allows the thermal barrier to be installed by spraying the material on top of the poly-urethane foam insulation, thereby significantly speeding up the application process.

Furthermore, the present method for installing a cellulose fiber thermal barrier allows poly-urethane foam insulation to be used on surfaces without wood or steel studs, as the cellulose fiber thermal barrier may be applied on top of the poly-urethane foam without the need for wood or steel studs to support conventional thermal barriers as described above.

In an embodiment, the cellulose fiber thermal barrier is applied at a thickness of about 1¼ to 1½ inches to act effectively as a thermal barrier that when exposed to a temperature of 704° C., will increase by no greater than 140 degrees C. when measured at a 10 minute interval.

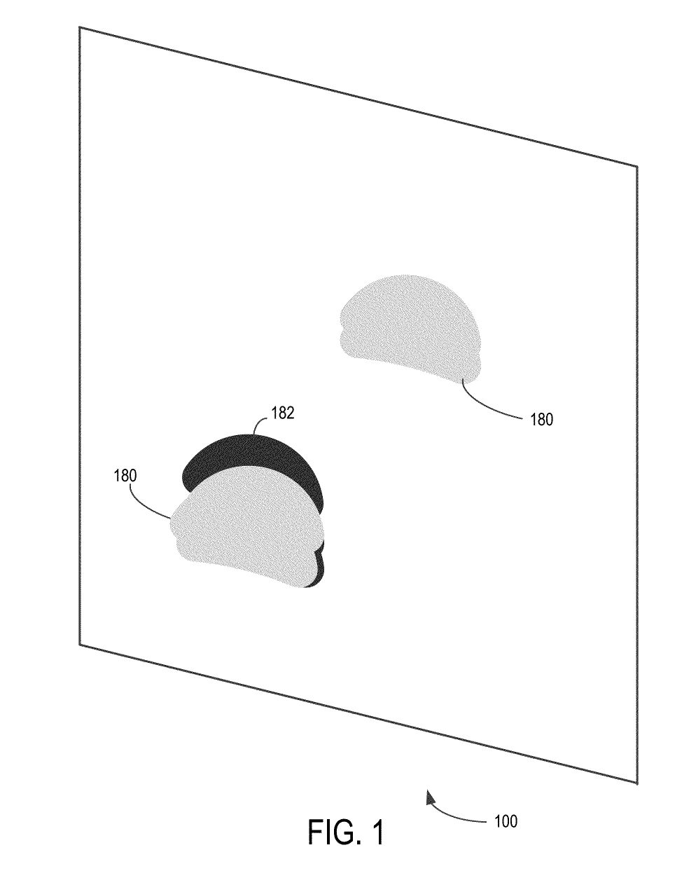

An illustrative example of a wall surface to which the cellulose fiber thermal barrier 180 is applied is shown in FIG. 1. As shown, the cellulose fiber thermal barrier 180 may be applied directly to a surface such as wall 100. Alternatively, cellulose fiber thermal barrier 180 may also be applied on top of a flammable insulation material 182, such as poly-urethane foam insulation, in order to protect the flammable insulation material 182 with a fire barrier.

### Preparation of Cellulose Fiber Insulation Mixture

### First Embodiment

In a first illustrative embodiment, the inventor has found that the following ingredients results in a dry cellulose fiber thermal barrier mixture with desirable qualities for application as shown in Table 1:

TABLE 1
Additives to 13.6 kg bag of cellulose fiber thermal barrier material

| | |
|---|---|
| Joint compound (e.g. Durabond ® 20) | 5 kg |
| Liquid binder mix (liquid glue) | 90% |
| (e.g. FB-133-LG) | |
| Dry powder glue (e.g. FB-233-PG) | 5 kg |
| Dry fire retardant powder (e.g. FB-333-FR) | 5 kg |
| Water mixed with liquid binder | 10% |
| Add water to dry cellulose fiber insulation | 40% to 60% |

The dry additives in the above table are mixed until evenly blended, before any liquid is added. In an illustrative embodiment, the mixing process comprises starting with about 5 kg of joint compound, and adding about 5 kg of dry powder glue (e.g. FB-233-PG manufactured by Bond Tech Industries Inc. of Brampton, Ontario, Canada) with 5 kg of dry fire retardant powder (e.g. FB-333-FR manufactured by Bond Tech Industries Inc. of Brampton, Ontario, Canada). For example, the inventor has found Durabond® 20, manufactured by CGC Inc. of Mississauga, Ontario, Canada, to be a suitable joint compound material for use in the mixture. A suitable liquid binder mix is FB-133-LG, manufactured by Bond Tech Industries Inc. of Brampton, Ontario, Canada. However, it will be appreciated that other similar material may also be used.

### Second Embodiment

In a second illustrative embodiment, the inventor has found that the following ingredients results in a cellulose fiber thermal barrier mixture with desirable qualities for application as shown in Table 2:

TABLE 2
Additives to 13.6 kg bag of cellulose fiber thermal barrier material

| | |
|---|---|
| Joint compound (e.g. Durabond ® 20) | 2.2 kg |
| Liquid binder mix (liquid glue) | 60% |
| (e.g. FB-133-LG) | |
| Dry powder glue (e.g. FB-233-PG) | 2.2 kg |
| Dry fire retardant powder (e.g. FB-333-FR) | 2.2 kg |
| Water mixed with liquid binder | 40% |
| Add water to dry cellulose fiber insulation | 15% to 25% |

The dry additives in the above table are mixed until evenly blended, before any liquid is added. In an illustrative embodiment, the mixing process comprises starting with about 2.2 kg of joint compound, adding about 2.2 kg of dry powder glue (e.g. FB-233-PG), and about 2.2 kg of dry fire retardant powder (FB-333-FR).

### Third Embodiment

In a third illustrative embodiment, the inventor has found that the following ingredients results in a cellulose fiber thermal barrier mixture with desirable qualities for application as shown in Table 3:

TABLE 3
Additives to 13.6 kg dry bag of cellulose fiber thermal barrier material

| Joint compound (e.g. Durabond ® 20) | 0.056 kg |
|---|---|
| Liquid binder mix (liquid glue) | 10% |
| (e.g. FB-133-LG) | |
| Dry powder glue (e.g. FB-233-FG) | 0.056 kg |
| Dry fire retardant powder (e.g. FB-333-FR) | 0.056 kg |
| Water mixed with liquid binder | 90% |
| Add water to dry cellulose fiber insulation | 0% |

The dry additives in the above table are mixed until evenly blended, before any liquid is added. In an illustrative embodiment, the mixing process comprise starting with about 0.056 kg of joint compound, adding about 0.056 kg of dry powder glue (e.g. FB-233-PG), and 0.056 kg of dry fire retardant powder (e.g. FB-333-FR).

### Preparation of Cellulose Fiber Thermal Barrier Mixture

In an embodiment, the dry additives are mixed together with damp cellulose fiber insulation material at a manufacturing location in order to create a suitable cellulose fiber insulation material before it is brought to be applied on site.

The combination of Durabond® 20 drywall compound and dry powder glue adhesive and dry fire retardant powder, provides a contractor with a superior bonding thermal barrier to all types of surfaces, including ply-wood, metal and poly-urethane foam insulation.

### Setup and Method of Application

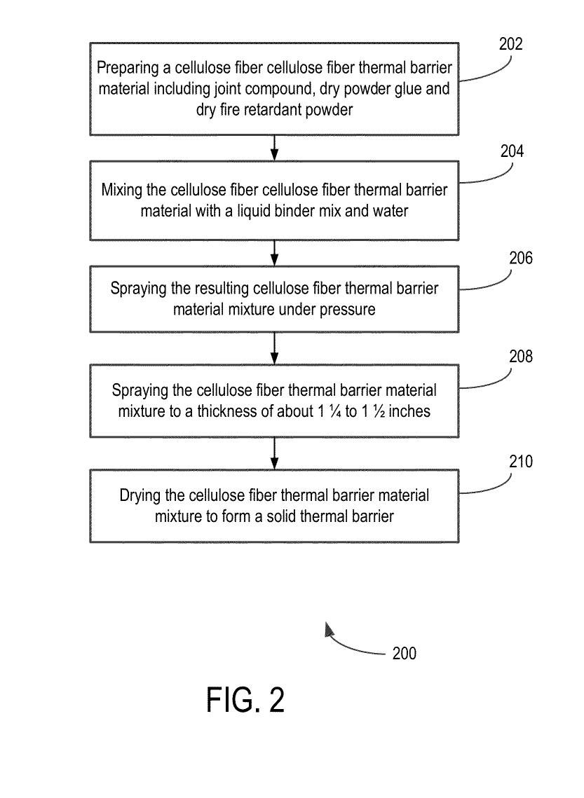

Now referring to FIG. 2, shown is an illustrative process for applying the cellulose fiber thermal barrier material as mixed in accordance to one of the illustrative embodiments described above.

In summary, the steps include preparing, at block 202 a cellulose fiber thermal barrier material including joint compound, dry powder glue and dry fire retardant powder; mixing, at block 204, the cellulose fiber thermal barrier material with a liquid binder mix and water; and spraying, at block 206, the mixture under pressure. In order to achieve certain industry standards, at block 208, the cellulose fiber thermal barrier material mixture is sprayed to a thickness of about 1¼ to 1½ inches. At block 210, the mixture is then allowed to dry in order to form a solid thermal barrier.

At all job sites, to insure good adhesion, all surfaces where the cellulose fiber thermal barrier is to be installed should be dry and clean of oils, water and ice or the sprayed application may fail. Also the area where the cellulose fiber thermal barrier is to be applied should have an ambient temperature above 10° C. to maintain a sufficiently warm surface to apply the materials. This ambient temperature should remain relatively constant during application, and remain above freezing (at least about 8° C.-10° C.) for a minimum of about 5-7 days.

During fall and winter months, with drop in temperatures, extra care should be taken due to possible flash freezing for cold steel applications.

The damp cellulose fiber thermal barrier mixture is applied with a spray nozzle at a suitable pressure and distance from the wall. In preparation for applying the cellulose fiber thermal barrier material, a suitably sized spray tip may be selected. For example, one or more 4002 (40 degree angle, 0.02 litres per minute) size spray tips may be installed in an external spray nozzle at the end of the hose of a cellulose fiber insulation applicator.

A suitable length of a supply hose and return hose may be brought into the job location where the cellulose fibre thermal barrier material is to be sprayed. A common size of supply hose is a 3-inch diameter hose with internal water injection nozzles to again dampen down the cellulose fibre thermal barrier mix. Then the hose is reduced down to a 2½ inch diameter hose to the 4002 spray nozzle tips located at the end of the hose. However, it will be appreciated that any suitable sized return hose may be used to return any product that did not adhere to the substrate, back to the blown machine to be reinstalled.

Spray equipment may be checked as necessary, including checking oil levels in a power generator supplying electricity, and oil felt on shaft of liquid supply pump. The liquid supply pump may be purged and powered up. A typical supply pump pressure may be about 1500 psi to 2000 psi, although another suitable supply pump pressure may be used at similar pressures.

Next, a cellulose fibre material blowing machine may be filled up with specially designed bags of cellulose fibre insulation, made for example by Fibre Barrier Plus Inc. A suitable blowing machine may be, for example, a CM-2400 model or a CM-3500 model blowing machine manufactured by Cool Machine of Ohio, USA. Alternative blowing machines may also be suitable. Examples of suitable machine settings on the CM-2400 are: dry feed hopper setting 4, wet feed hopper setting 2 and blower speed setting to 7. As will be appreciated, these illustrative settings on these Cool Machine models may vary on different blown machine models, and each machine will have to be suitably calibrated to achieve the desired operating conditions for application.

During application, the damp cellulose fiber thermal barrier mixture is applied to the surface in a back and forth movement to a required depth of about 1¼ to 1½ inches thick. Using 2-4002 tips at the nozzle and maintaining approximately a 90° angle to the surface being applied to reduce the amount of blow off. When done properly, approximately 90 to 95 percent of the material will remain on the applied surface with a dense pack effect. The cellulose fiber thermal barrier mixture should preferably be totally saturated with the water/liquid-glue binder.

Advantageously, when applied correctly as instructed and allowed to dry, the applied cellulose fiber mixture will provide an effective 10-minute thermal barrier in compliance with the CAN4-2124-M standard of the National Building Code, and with CAN/ULC S1010-M. Furthermore, as the cellulose fiber material is itself an insulator, the cellulose fiber thermal barrier mixture further provides an insulation effect of its own, in addition to any underlying flammable insulation material which the cellulose fiber thermal barrier is protecting.

Thus, in an aspect, there is provided a method of applying a cellulose fiber thermal barrier material; comprising: preparing a cellulose fiber thermal barrier material including joint compound, dry powder glue and dry fire retardant powder; mixing the cellulose fiber cellulose fiber thermal barrier material with a liquid binder mix and water; and spraying the resulting cellulose fiber thermal barrier material mixture under pressure.

In an embodiment, the method further comprises spraying the cellulose fiber thermal barrier material mixture on a vertical surface.

In another embodiment, the method further comprises spraying the cellulose fiber thermal barrier material mixture on top of a flammable insulation material.

In another embodiment, the flammable insulation material is poly-urethane foam insulation.

In another embodiment, the method further comprises spraying the cellulose fiber thermal barrier material mixture to a thickness of about 1¼ to 1½ inches.

In another embodiment, the method further comprises drying the cellulose fiber thermal barrier material mixture to form a solid thermal barrier that when exposed to a temperature of 704° C. will increase by no greater than 140° C. when measured at a 10 minute interval.

In an embodiment, the method further comprises spraying the cellulose fiber thermal barrier material mixture at an ambient temperature above 10° C.

In an embodiment, the method further comprises providing a liquid glue as the liquid binder mix.

In an embodiment, the method further comprises spraying the cellulose fiber thermal barrier material mixture utilizing a blower.

In an embodiment, the method further comprises utilizing a supply pump pressure of about 1500 psi to 2000 psi.

In another aspect, there is provided a cellulose fiber thermal barrier material, comprising: cellulose fiber; joint compound; dry powder glue; and dry fire retardant power; wherein, when the cellulose fiber thermal barrier material is mixed with a liquid binder mix and water, the resulting mixture is sprayable onto a vertical surface.

In an embodiment, the cellulose fiber thermal barrier material mixture is sprayable on a vertical surface.

In another embodiment, the cellulose fiber thermal barrier material mixture is sprayable on top of a flammable insulation material.

In another embodiment, the flammable insulation material is poly-urethane foam insulation.

In another embodiment, the cellulose fiber thermal barrier material mixture is sprayable to a thickness of at least about 1¼ to 1½ inches.

In another embodiment, when cellulose fiber thermal barrier material mixture is dried, it forms a solid thermal barrier that when exposed to a temperature of 704° C. will increase by no greater than 140° C. when measured at a 10 minute interval.

In another embodiment, the liquid binder mix is liquid glue.

In another embodiment, the cellulose fiber thermal barrier material mixture is adapted to be sprayed utilizing a blower.

In another embodiment, the cellulose fiber thermal barrier material mixture is adapted to be sprayed utilizing a supply pump pressure of about 1500 psi to 2000 psi.

While illustrative embodiments have been described above by way of example, it will be appreciated that various changes and modifications may be made without departing from the scope of the invention, which is defined by the following claims.

1. A method of applying a cellulose fiber thermal barrier material; comprising:
preparing a cellulose fiber thermal barrier material including joint compound, dry powder glue and dry fire retardant powder;
mixing the cellulose fiber cellulose fiber thermal barrier material with a liquid binder mix and water; and
spraying the resulting cellulose fiber thermal barrier material mixture under pressure.

2. The method of claim 1, further comprising spraying the cellulose fiber thermal barrier material mixture on a vertical surface.

3. The method of claim 1, further comprising spraying the cellulose fiber thermal barrier material mixture on top of a flammable insulation material.

4. The method of claim 3, wherein the flammable insulation material is poly-urethane foam insulation.

5. The method of claim 1, further comprising spraying the cellulose fiber thermal barrier material mixture to a thickness of about 1¼ to 1½ inches.

6. The method of claim 5, further comprising drying the cellulose fiber thermal barrier material mixture to form a solid thermal barrier that when exposed to a temperature of 704° C. will increase by no greater than 140° C. when measured at a 10 minute interval.

7. The method of claim 5, further comprising spraying the cellulose fiber thermal barrier material mixture at an ambient temperature above 10° C.

8. The method of claim 1, further comprising providing a liquid glue as the liquid binder mix.

9. The method of claim 1, further comprising spraying the cellulose fiber thermal barrier material mixture utilizing a blower.

10. The method of claim 8, further comprising utilizing a supply pump pressure of about 1500 psi to 2000 psi.

11. A cellulose fiber thermal barrier material, comprising:
cellulose fiber;
joint compound;
dry powder glue; and
dry fire retardant power;
wherein, when the cellulose fiber thermal barrier material is mixed with a liquid binder mix and water, the resulting mixture is sprayable onto a vertical surface.

12. The cellulose fiber thermal barrier material of claim 11, wherein the cellulose fiber thermal barrier material mixture is sprayable on a vertical surface.

13. The cellulose fiber thermal barrier material of claim 11, wherein the cellulose fiber thermal barrier material mixture is sprayable on top of a flammable insulation material.

14. The cellulose fiber thermal barrier material of claim 13, wherein the flammable insulation material is poly-urethane foam insulation.

15. The cellulose fiber thermal barrier material of claim 14, wherein the cellulose fiber thermal barrier material mixture is sprayable to a thickness of at least about 1¼ to 1½ inches.

16. The cellulose fiber thermal barrier material of claim 15, wherein, when dried, the cellulose fiber thermal barrier material mixture forms a solid thermal barrier that when exposed to a temperature of 704° C. will increase by no greater than 140° C. when measured at a 10 minute interval.

17. The cellulose fiber thermal barrier material of claim 1, wherein the liquid binder mix is liquid glue.

18. The cellulose fiber thermal barrier material of claim 1, wherein the cellulose fiber thermal barrier material mixture is adapted to be sprayed utilizing a blower.

19. The cellulose fiber thermal barrier material of claim 18, wherein the cellulose fiber thermal barrier material mixture is adapted to be sprayed utilizing a supply pump pressure of about 1500 psi to 2000 psi.
